(19) United States
(12) Patent Application Publication
(10) Pub. No.: US 2018/0356950 A1
(43) Pub. Date: Dec. 13, 2018

(54) SYSTEM AND METHOD FOR APPLICATION NAVIGATION

(71) Applicant: Alibaba Group Holding Limited, George Town, KY (US)

(72) Inventors: Wenhan Bian, Hangzhou (CN); Ming Cai, Hangzhou (CN); Haixin Wang, Hangzhou (CN); Feng Zheng, Hangzhou (CN); Yan Zou, Hangzhou (CN)

(21) Appl. No.: 15/990,215

(22) Filed: May 25, 2018

(30) Foreign Application Priority Data
Jun. 7, 2017 (CN) 201710423947.7

(51) Int. Cl. G06F 3/0484; G06F 3/0488; G06F 3/0481

(52) U.S. Cl. CPC G06F 3/0484; G06F 3/04817; G06F 3/04883

(57) ABSTRACT

Application navigation is disclosed including determining applications included in an application folder, acquiring information corresponding to at least one of the applications based on the applications included in the application folder, and outputting a service interface corresponding to the application folder, the service interface including an area to display the acquired information.

### CROSS REFERENCE TO OTHER APPLICATIONS

This application claims priority to People's Republic of China Patent Application No. 201710423947.7 entitled AN APP NAVIGATION METHOD AND MEANS, filed Jun. 7, 2017 which is incorporated herein by reference for all purposes.

### FIELD OF THE INVENTION

The present application relates to a system and method for application navigation.

### BACKGROUND OF THE INVENTION

As communication technologies develop, numerous terminal applications (apps) are installed on terminal devices in order to satisfy constantly growing business requirements. The terminal desktop, also known as the system interface or the main interface, is typically used for application (app) navigation. Using the mobile phone as an example, the desktop of the mobile phone can be displayed as a set of application icons. After clicking on a particular application icon, a user can enter an application program corresponding to the application icon or activate a service corresponding to the application icon.

To provide users with faster and more convenient application navigation functions, conventionally, folders are displayed on the mobile phone desktop. The folders include multiple application icons. Icons for application programs of the same type can be located in one folder to assist users in selecting the application programs that they are to use from among the application programs of the same type.

Although users can be provided with convenient and fast navigation functions using the folder approach, the application navigation performed using the folders technique only involves application navigation in terms of the search paths of application portals. Traditional application navigation techniques typically require the user to remember the location of specific applications or folders and navigate through a series of folders to reach the specific applications or folders, which is sometimes time consuming and inconvenient. As user requirements continue to grow, providing users with enhanced application navigation services would be desirable.

### BRIEF DESCRIPTION OF THE DRAWINGS

Various embodiments of the invention are disclosed in the following detailed description and the accompanying drawings.

FIG. 1 is an example of a network architecture for application navigation.

FIG. 2A is a first example of a service interface.

FIG. 2B is a second example of a service interface.

FIG. 2C are examples of service interfaces.

FIG. 3 is a functional structure of an embodiment of a client for application navigation.

FIG. 4 is a functional structure of another embodiment of a client for application navigation.

FIG. 5 is a functional structure of yet another embodiment of a client for application navigation.

FIG. 6 is a functional structure of an embodiment of a server for application navigation.

FIG. 7 is a flow chart of an embodiment of a process for application navigation.

FIG. 8 is an example of a process for creating a service interface.

FIG. 9 is an example of a processing flow of a user downloading and installing an application program.

FIG. 10 is another example of a processing flow of a user downloading and installing an application program.

FIG. 11 is an example of how a terminal desktop changes when application programs of the same type are merged into a corresponding service interface.

FIG. 12 is an example of a processing flow for merging multiple application programs into a corresponding service interface.

FIG. 13 is an example of how a terminal desktop changes in a context of executing a “Classify All” desktop management command.

FIG. 14 is an example of a process whereby a service interface corresponding to an application folder is presented on a desktop when a user requests to open the folder.

FIG. 15 is a functional diagram illustrating a programmed computer system for application navigation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

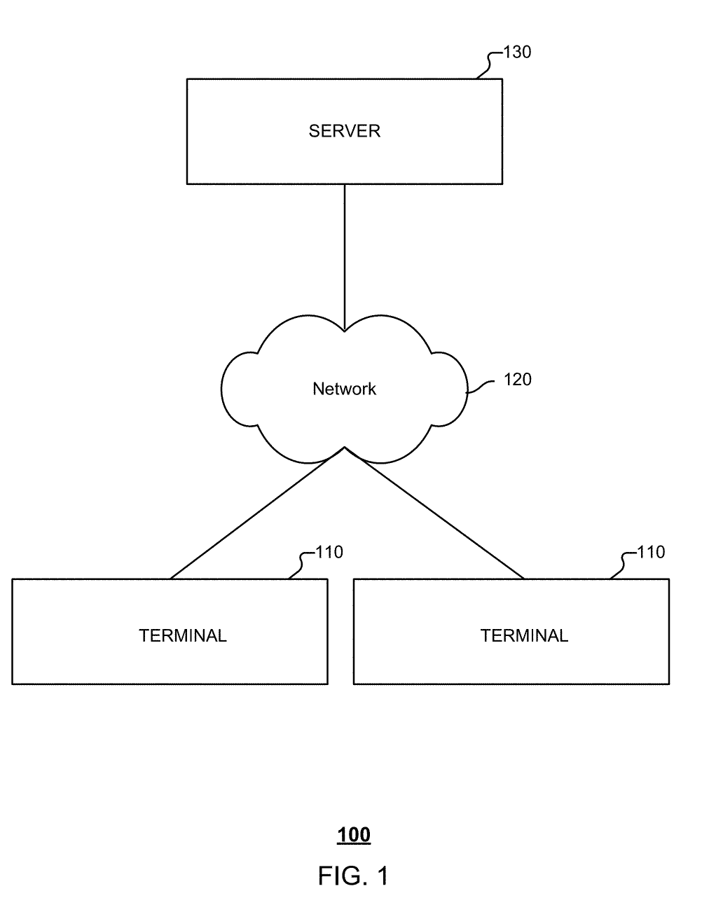

FIG. 1 is an example of a network architecture for application navigation. In some embodiments, the network architecture 100 includes terminals 110 and a server 130. The number of terminals 110 can be more than one, and the number of servers can also be more than one (only one server is shown in FIG. 1). The terminals 110 and the server 130 can communicate via a network 120.

The terminals 110 can include client application programs (service interface clients or clients). The server 130 can include server application programs (service interface servers or servers). The clients 110 and the server 130 can work together to implement application navigation functions. In some embodiments, the clients can be third party application clients, and the server can be a third party application server. In some embodiments, the clients are clients provided by operating systems, and the server is a server provided by the operating systems. The operating systems can include cloud operating systems (e.g., YunOS).

The terminals 110 can be mobile terminals, personal computers (PCs), or other such devices. The mobile terminals can be mobile phones, personal digital assistants (PDAs), vehicle-mounted terminals, smart wearable devices, etc.

In the network architecture 100, the terminals 110 and the server 130 can exchange information via a network 120. The network could be a wide-area network, local-area network, the Internet, the Internet using mobile communication technology, etc. The terminals 110 can wirelessly access the Internet. The server 130 typically is connected to the Internet via cables, wires, etc.

In some embodiments, optionally, the terminals 110 and the server 130 can use cloud computing technology and implement information processing using powerful functions based on cloud computing technology. The terminals 110 and the server 130 can employ a cloud computing technology-based operating system such as a cloud operating system (e.g., YunOS) and thus be capable of integrating cloud and terminal resources and services. For example, the cloud computing technology-based operating system can use user personalized information on the cloud.

In some embodiments, clients and servers implement various applications and services based on application programs, service components, or service resources. Using the YunOS operating system as an example, clients and servers implement various services based on Page in YunOS. “Page” is an abstraction of a local service and a remote service, i.e., the basic unit of service. By packaging data and methods, Pages can provide various kinds of services. A service context can include multiple Pages. For example, Page is a UI (user interface) or a service such as picture-taking. In another example, Page is a background service, such as account authentication. Each Page can be uniquely identified in YunOS.

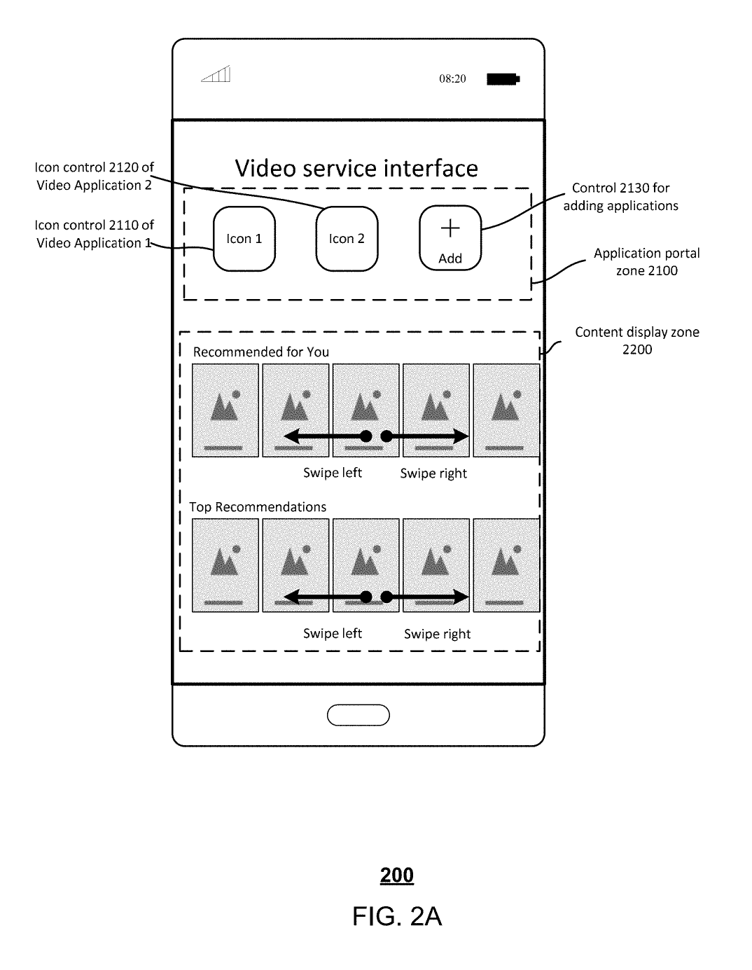

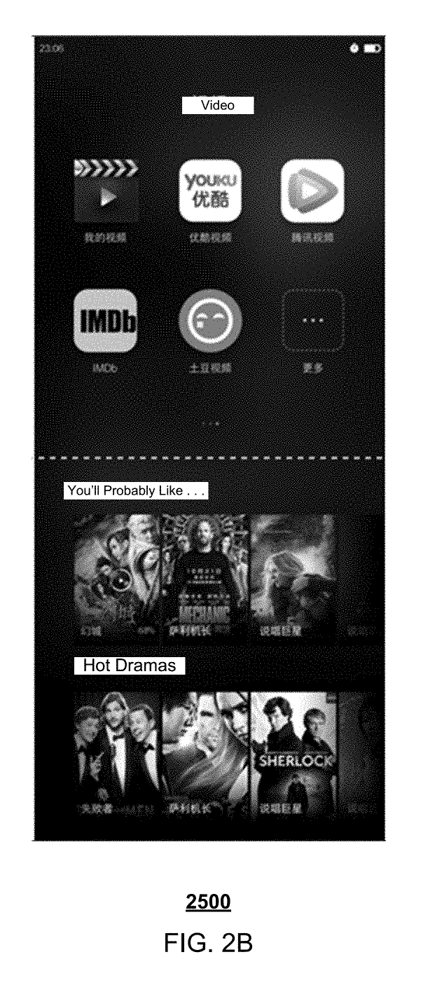

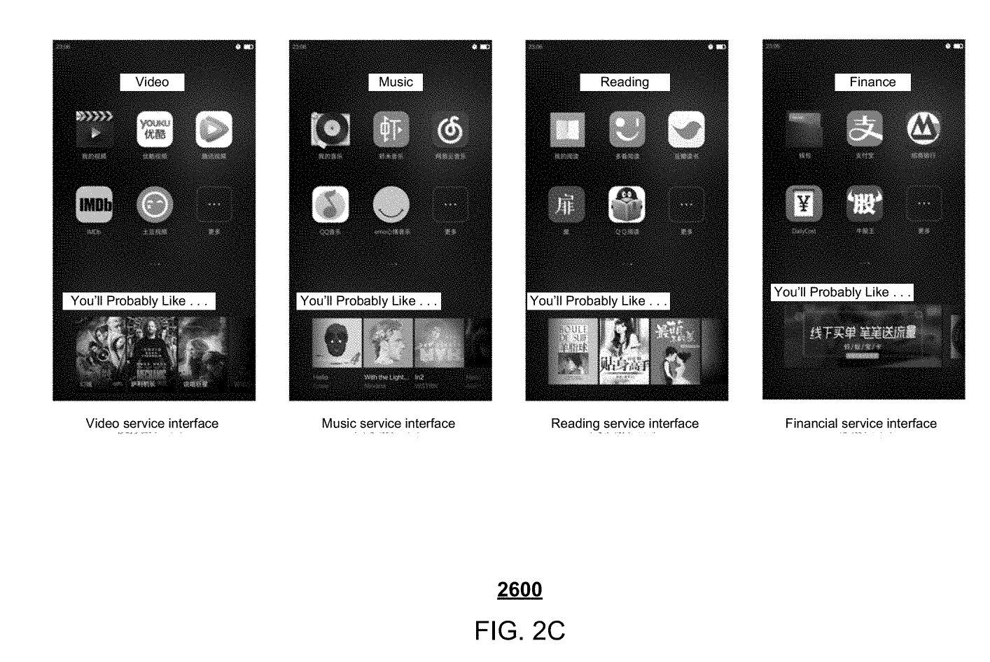

In some embodiments, the client generates, manages, or both application folders on the terminal desktop. One application folder can correspond to one service interface. In the event that the user requests to open an application folder using a touchscreen operation (such as a click or tap operation) or by another operation or requests to open an application folder through another form of triggering, the service interface corresponding to the application folder can be opened. The user can, based on application portals, content portals, or both provided by the service interface, select a corresponding application or view corresponding content. As an example, in FIG. 2C, the video service interface has two parts, the upper part corresponds to an application portal, which includes some application icons that the user can click to start an application, and the lower part corresponds to a content portal, which includes some movie poster images that user can click to watch a movie.

In some embodiments, an “application folder” contains one or more applications, and one application folder corresponds to one service interface. The service interface can include one or more pieces of information corresponding to applications, e.g., content portals (or resource portals) of the one or more applications. The service interface can further include application portals to provide the user with a fast and convenient way of activating contents or resources appropriate to the applications or methods. In some examples, “application folders” are desktop folders. “Desktop” is a computer term. The desktop can correspond to the main screen area viewed after opening or turning on a computer device and logging in to the system. For example, the main screen one views after turning on a terminal, such as a mobile phone, and logging in is called the desktop and is the system operating platform. Application program icons can be located on the desktop. Each of the application program icons can correspond to an application program. By performing an operation on the application icon, the corresponding application program can be executed.

In some embodiments, the service interface associated with an application folder includes portals of applications included in the folder and information corresponding to at least one application included in the application folder. In some embodiments, the information that is associated with an application and that is presented by the service interface can be externalized information relating to a content dimension of resources provided by the application and used to provide the user with a faster and more convenient application navigation function. For example, the externalized information includes descriptive information, content portals for resources provided by the application, resource portals for resources provided by the application, or any combination thereof. As an example, the information of an application includes one or more of the following:

Content (or resources) is provided by the application. The content provided by the application can appear in one or more of the following forms: text, pictures, video, animation, real-time information, etc., which are for giving the user a faster and more convenient understanding of the content provided by the application. For example, in the case of a video application, “content provided by the application” is images of movie posters, and the corresponding movie resources are provided by the video application. In another example, in the case of a financial application, “content provided by the application” is stock real-time market information provided by the financial application.

Application content portals (or resource portals) are provided by the application. A content portal can provide an application for the content upon being triggered and activated, and a resource corresponding to the content portal can be accessed via the application to provide a function for fast access to the corresponding resource.

As an example, the service interface comprises N pieces of content provided by at least one application (N is an integer greater than or equal to 1), and each piece of content is associated with a portal for that content. For example, the video application folder includes three video applications. Thus, the service interface corresponding to the video application folder can include portals for the three video applications and application content recommendation information for the three video applications. The application content recommendation information for the three video applications can appear as images of movie posters. An image of each movie poster can be associated with the application that provides the corresponding movie resource and an address of the corresponding movie resource. For example, the address of the corresponding movie resource is http://www.qiyi.com/dianying/20100727/n126741.html. After the user clicks on an image of a movie poster, the corresponding movie can be played through the corresponding video application.

Correspondingly, a service interface can include an application portal zone and a content display zone. The application portal zone can display the application portals included in the folder. The application portals can include icon controls for triggering the opening of applications. An example of an icon control is an icon of an application that the user can click to start the application. In the event that an icon control in the application portal zone is triggered (e.g., in the event that the user clicks the icon control), the application corresponding to the icon control is started. The content display zone can display information corresponding to applications included in the folder. The displayed information can be application content recommendation information.

The information corresponding to the applications displayed in the service interface can come from a server. The server can, based on application usage statistical data, user information, or a combination thereof, compile information that corresponds to the applications and that is used for display in the service interface. For example, in the case of a video application, the server counts video application play instances for an interval of time and thereby compiles information relating to the 10 most-played video resources. In another example using the video application, the server acquires user personalized information (such as user preferences) and compiles types of video resources that the user plays more often or is likely to play based on the user personalized information. Please note that the content recommendation techniques employed by the server are not limited to the techniques listed above.

As an aspect, the server can compile statistics based on one or more dimensions. Accordingly, application-related information displayed in the service interface can be partitioned into multiple groups based on statistical dimensions. Using video applications as an example, a statistical dimension can be to compile statistics on viewership of video resources by all users. Another dimension can be to compile statistics on user viewership based on information on specific users. Accordingly, the service interface could partition statistically compiled application recommendation content information based on the statistical dimensions into two groups: “Top Recommendations” and “Recommended for You.”

One group of content can occupy one display zone within the service interface, and all of the content in the other group can be displayed in a display zone corresponding to another group of content. Although the size of a service interface is limited and yet a large amount of recommendation content can exist, the display zone corresponding to one group of content can display a portion of the content. If the displayed portion of the content in the one group exists in the display zone corresponding to the one group of content, the display zone can include an interface element for triggering the viewing of another portion of the content in that group. For example, the display zone displays the text “More,” and the text is linked to the next page of content to be displayed. When the user clicks the text “More,” the user can view the next page of content in that group. The display zone can also provide a function to view other content in the group using a swipe operation. For example, the user can view information in the group by swiping left or swiping right.

A service interface can include, in addition to the application portal zone and the content display zone, a zone for other functions, such as a zone for displaying other function controls. The other function controls can include controls for implementing application go-to functions. An example of another function control can be a link to go to an “Application Download Center.” In some embodiments, the “Application Download Center,” which is a system service provided by the operating system, makes download resources for various application programs available to users so that the users can choose various application programs for download and installation.

There is no restriction on the layouts of the service interfaces. To facilitate use, the application portal zone and the content display zone can be centered separately. For example, the upper part of a service interface is the application portal zone, and the lower part of the service interface is the content display zone. In another example, the upper part of the service interface is the content display zone, and the lower part of a service interface is the application portal zone. A size of each zone can be set based on how much of the screen space the displayed content occupies.

Please note that the service interface described above by the present application includes the application portals and information corresponding to the applications (e.g., content portals). In some embodiments, the application portals in the service interface are optional. In other words, the service interface is not required to include application portals, but is to include information corresponding to the applications (e.g., content portals).

FIG. 2A is a first example of a service interface. The service interface 200 is a service interface for a video type displayed on a mobile phone desktop. As shown in FIG. 2A, the service interface 200 includes an application portal zone 2100 and a content display zone 2200. The application portal zone 2100 comprises an icon control 2110 for Video Application 1 and an icon control 2120 for Video Application 2. The application portal zone 2100 can further include a control 2130 for adding applications to the service interface. After the control 2130 is triggered, the control 2130 executes a process to add an application to the service interface. The content display zone 2200 includes a list of videos recommended for the user (e.g., “Recommended for You” content) and a list of popular videos (e.g., “Top Recommendations” content). The video list can appear as a series of images corresponding to video resources. Swiping can cause the series of images corresponding to the video resources of “Recommended for You” to scroll left or right and thus limiting the videos to be played. In one example, swiping causes the series of images corresponding to the video resources of the “Top Recommendations” video list to scroll left or right. The “Recommended for You” video list can include recommended video resources for Video Application 1 and recommended video resources for Video Application 2. In another example, the “Top Recommendations” video list can include recommended video resources for Video Application 1 and recommended video resources for Video Application 2. After an image associated with a video resource in the video list is selected, the corresponding video application can be executed to play the selected video resource.

Please note that FIG. 2A is merely an example. No restrictions on the positions of the application portal zone and the content display zone are placed within a service interface. For example, the content display zone is located above the application portal zone. As another example, more than one application portal zone and content display zone exists, depending on the number of video applications included in the service interface. In this case, one application portal zone is to display one video application icon control, and one content display zone is to display recommendation content for one application. In addition, the application portal zones and content display zones are to be laid out as follows: the service interface is partitioned into multiple rows, and each row displays on its left side one video application icon control and on its right side the recommendation content for the video application.

FIG. 2B is a second example of a service interface. In some embodiments, the service interface 2500 is a service interface of a video type. The service interface 2500 includes an upper part and a lower part (separated by a dashed line). The upper part displays application program icons for multiple video applications. The lower part displays two video recommendation lists: “You Might Like” and “Popular Shows.” Different video recommendation lists are compiled using different techniques. Each video recommendation list includes multiple video images, and each video image is associated with one video resource. By clicking one of the video images, a user can open an application that provides the video resource and play the corresponding video resource using the application. Each video recommendation list also permits the user to slide the list to the left or the right to view additional content of the video recommendation list.

In some embodiments, a service interface corresponding to an application folder exists. Therefore, the service interface includes application portals and information corresponding to applications. Unlike conventional service interfaces, the service interface corresponding to the application folder can provide application portals, and can also provide information corresponding to applications (such as, for example, application recommendation content information). Thus, instead of only providing an application folder of application portals, the application folder can add an application navigation dimension. Therefore, users can be provided with application navigation functions that are faster and more convenient than with conventional application navigation functions.

The server can provide content recommendation functions because not all of the applications are involved. Typically, the server provides application recommendation functions for some applications or some types of applications. Examples of various type of applications include video applications, music applications, reading applications, business applications, travel applications, etc. Therefore, in some embodiments, the application folder type and the service interface type are defined, and each application folder's type is the same as the type of the service interface corresponding to that application folder. In some embodiments, an application folder's type is the same as the type of the service interface. As an example, a server defines four different service interface types: Music, Video, Reading, and Financial. The applications that can be included in each type of application folder or service interface can also be defined. The server can provide content recommendation functions for applications included in the application folder or the service interface.

As an example, a server defines four service interface types:

Music type: A service interface of the music type includes music applications (such as, for example, applications that provide music resource online playing services and music resource download services), i.e., mainly provides application portals and content display for music applications.

Video type: A service interface of the video type includes video applications (such as, for example, applications that provide video resource online playing services and video resource download services), i.e., mainly provides application portals and content display for video applications.

Reading type: A service interface of the reading type includes reading applications (such as, for example, applications that provide online reading services for online reading resources and reading resource download services), i.e., mainly provides application portals and content display for reading applications.

Financial type: A service interface of the financial type includes financial applications, i.e., mainly provides application portals and content display for financial applications.

FIG. 2C are examples of service interfaces. In some embodiments, the service interfaces 2600 include the four types of service interfaces described above. The upper part of the video service interface includes multiple icons of video applications. The lower part includes a video recommendation list. The posters in lower part of the videos of FIG. 2C represent videos of the video recommendation list. This video recommendation list includes multiple video images, and each video image is associated with a corresponding video resource. The video resources associated with the video images can come from one or more of the applications displayed in the upper part. The upper part of the music service interface includes multiple icons of music applications. The lower part of the music service interface includes a music recommendation list. The compact disc (CD) covers of the lower part of FIG. 2C represent the music recommendation list. The music recommendation list includes multiple music resource images, and each image is associated with a corresponding music resource. The music resources associated with the image can come from one or more of the applications displayed in the upper part of the music service interface. The upper part of the reading service interface includes multiple icons of reading applications. The lower part of the reading service interface includes a reading recommendation list. The book covers of FIG. 2C represent the reading recommendation list. The reading recommendation list includes multiple reading resource images, and each image is associated with a corresponding reading resource. The reading resources associated with the images can come from one or more of the applications displayed in the upper part. The upper part of the financial service interface includes multiple finance icons. The lower part of the financial service interface includes a recommendation list. The recommendation list includes multiple finance resource images, and each image is associated with a corresponding finance resource. The finance resources associated with the images can come from one or more of the applications displayed in the upper part.

Typically, one type of application folder or service interface can include a single type of application. For example, a music service interface includes music applications, and a reading service interface includes reading applications. A user can use one type of application program while also using another type of application program. Therefore, in some embodiments, a type of service interface is permitted to include multiple types of applications. For example, the user both listens to music and reads online using their phone. Therefore, the reading service interface can include music applications. Thus, in the event that the user opens the reading service interface, the reading service interface can include portals for music applications and portals for reading applications, as well as recommendation content relating to music applications and reading applications. In this way, the user, through the service interface, can select a reading application or a reading resource and also select a music application or a music resource. The user can be provided with a convenient and fast application navigation function.

In some embodiments, the layout of the service interface is defined by a service interface template. The service interface template can be configured by a server. The client can acquire the service interface template from the server, and the server can also send an updated service interface template to the client.

As an example, Table 1 presents, in tabular form, service interface configuration information. As an example, default configuration information can be installed with the operating system (OS), and the provider of the OS or other third party providers can provide other configuration information that the user can download or the server can push to the terminal. In another example, the user modifies the configuration information. The service interface configuration information can be used to define the ID of the service interface, the service interface template used by the service interface, the title of the service interface (the title is displayed in the service interface), and other such content.

TABLE 1
Service Interface Configuration Information

| Service | | Service | | |
|---|---|---|---|---|
| interface | Service | interface | | |
| ID | interface title | template | Go-to address | Other |
| 1 | Video service | Template 1 | Application | . . . |
| | interface | | download center | |
| 2 | Music service | Template 1 | Application | . . . |
| | interface | | download center | |
| 3 | Reading service | Template 2 | Application | . . . |
| | interface | | download center | |
| 4 | Financial service | Template 3 | Application | . . . |
| | interface | | download center | |

Table 1 presents, as an example, configuration information of the four types of service interfaces. Using a video service interface as an example, according to the configuration information shown in Table 1, the service interface ID of the video service interface has a value of 1. When the service interface is displayed on the terminal, the displayed title is “Video Service Interface.” The service interface lays out the interface based on “Template 1.” The address (the “go-to address” in Table 1) associated with the control for implementing the go-to function in the service interface is the address for the “application download center.” As an example, when the user clicks the go-to function, the OS will start the application/function (e.g. Application Store) associated with the go-to address.

In some embodiments, the applications included in an application folder or service interface of one type, i.e., correspondences between applications and service interface types can also be configured by the server. The client can acquire the correspondences from the server. The server can also send the correspondences to the client after updating the correspondences.

As an example, Table 2 presents, in tabular form, correspondences of service interfaces to applications. The correspondences can include service interface IDs and application IDs. The service interface IDs and the application IDs can have a one-to-many relationship. In other words, one type of service interface can correspond to multiple applications. These applications can be applications of the same type, or the applications can be applications of different types.

TABLE 2
Correspondences of Service Interfaces to Applications

| Service | |
|---|---|
| interface | |
| ID | Application ID |
| 1 | Video Application 1, Video Application 2, |
| | Video Application 3 |
| 2 | Music Application 1, Music Application 2, |
| | Music Application 3 |
| 3 | Reading Application 1, Reading Application 2, |
| | Reading Application 3 |
| 4 | Financial Application 1, Financial Application 2, |
| | Financial Application 3 |

Table 2 presents, as an example, applications corresponding to each of the four types of service interfaces. Using a video service interface as an example, according to the correspondence shown in Table 2, the video service interface corresponds to an application list. This application list includes Video Application 1, Video Application 2, and Video Application 3. (Video Application 1, Video Application 2, and Video Application 3 each is indicated by a corresponding application program ID or other information capable of identifying the application program.) The server can provide a content recommendation function for Video Application 1, Video Application 2, and Video Application 3. Regarding other video application programs, the server does not provide a content recommendation function. Therefore, in the event that a service interface of the video type contains video applications other than the video applications listed in Table 2, the user is not provided with content recommendation service for the other video applications because the server is unable to provide the corresponding content recommendation functions. In some embodiments, the video service interface only includes the video applications listed in Table 2. In other embodiments, video applications other than the video applications listed in Table 2 can be included in the video service interface. In such a situation, the video service interface is to provide only application portal functions for the other video applications.

In addition, as shown in Table 2, the applications corresponding to the reading service interface include music applications in addition to reading applications. Thus, within the reading application service interface, the reading application service interface can provide portals for reading applications and portals for music applications, and the reading applications and the music applications can provide recommendation content.

Tables 1 and 2 can also be merged into a single table, or service interface configuration information and correspondences between service interfaces and applications can be set up within a single configuration file, i.e., the correspondences between the service interfaces and the applications are a part of the service interface configuration information. No restrictions are placed on how the service interface configuration information is presented.

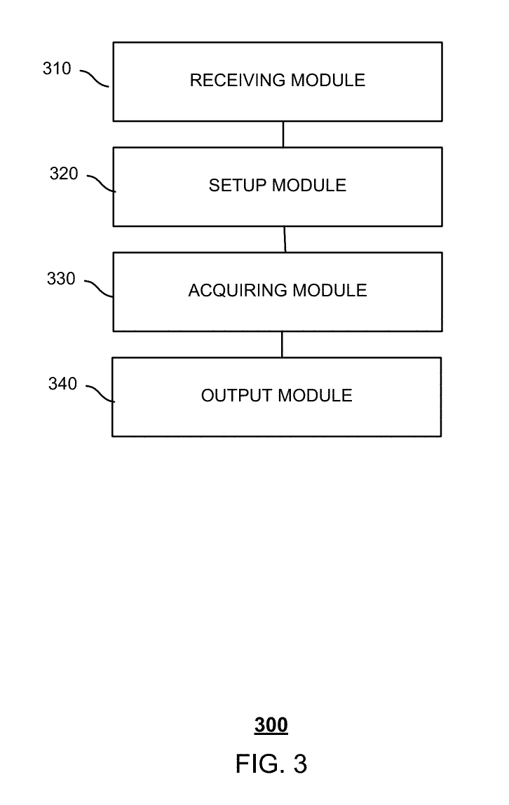

FIG. 3 is a functional structure of an embodiment of a client for application navigation. In some embodiments, the client 300 corresponds to a terminal 110 of FIG. 1, is configured to implement application folder setup functions, and comprises: a receiving module 310, a setup module 320, an acquiring module 330, and an output module 340.

In some embodiments, the receiving module 310 is configured to receive a request for triggering setup of a first application in an application folder. In some embodiments, the setup module 320 is configured to set up the first application in the application folder associated with the first application based on the request received by the receiving module 310. In some embodiments, the acquiring module 330 is configured to acquire information corresponding to at least one of the applications based on applications included in the application folder. In some embodiments, the output module 340 is configured to output a service interface corresponding to the application folder. The outputted service interface can be displayed on a terminal desktop. The service interface comprises the acquired information.

The “first application” does not specify a specific application or some specific applications, but serves as a convenient descriptive expression.

In some embodiments, the client 300 further includes a display (not shown). The display can include a displaying module such as a display screen, and the displaying module can display a service interface corresponding to an application folder, and the application folder can include a portal for at least one application. The service interface can include information provided by the at least one application included in the application folder.

The modules described above can be implemented as software components executing on one or more general purpose processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

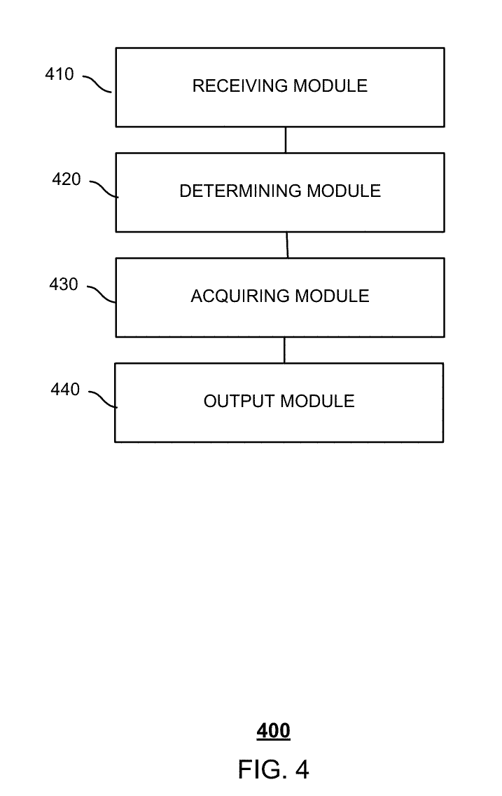

FIG. 4 is a functional structure of another embodiment of a client for application navigation. In some embodiments, the client 400 corresponds to a terminal 110 of FIG. 1, is configured to implement application folder display functions based on requests to open application folders, and comprises: a receiving module 410, a determining module 420, an acquiring module 430, and an output module 440. In some embodiments, the receiving module 410 is optional. In some embodiments, the determining module 420 is configured to determine applications included in an application folder. In some embodiments, the acquiring module 430 is configured to acquire information associated with at least one of the applications based on the applications included in the application folder. In some embodiments, the output module 440 is configured to output a service interface corresponding to the application folder. The outputted service interface can be displayed on a terminal desktop. The service interface includes the acquired information. In some embodiments, the receiving module 410 receives a request to open an application folder. In some embodiments, the determining module 420 is configured to determine the applications included in the application folder based on the request.

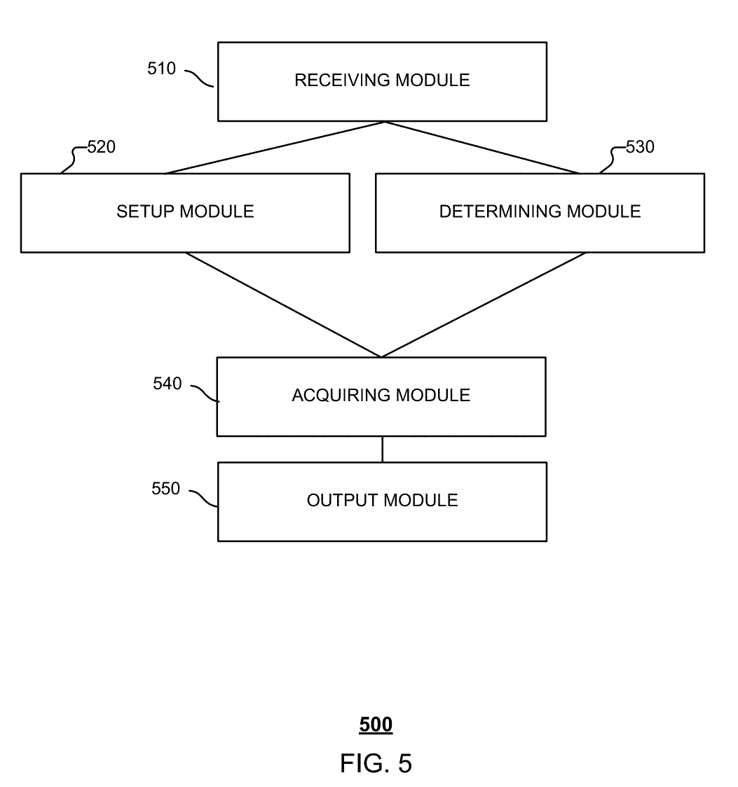

The client 300 of FIG. 3 and the client 400 of FIG. 4 can be merged to form a client 500 of FIG. 5. FIG. 5 is a functional structure of yet another embodiment of a client for application navigation. The client 500 can implement an application folder setup function and an application folder display function in response to a request to open an application folder. In some embodiments, the client 500 corresponds to a terminal 110 of FIG. 1, and includes: a receiving module 510, a setup module 520, a determining module 530, an acquiring module 540, and an output module 550. In some embodiments, the receiving module 510 corresponds to the receiving module 310 of FIG. 3 and/or the receiving module 410 of FIG. 4. In some embodiments, the setup module 520 corresponds to the setup module 320 of FIG. 3. In some embodiments, the determining module 530 corresponds to the determining module 420 of FIG. 4. In some embodiments, the acquiring module 540 corresponds to the acquiring module 330 of FIG. 3 and/or the acquiring module 430 of FIG. 4. In some embodiments, the output module 550 corresponds to the output module 340 or FIG. 3 and/or the output module 440 of FIG. 4.

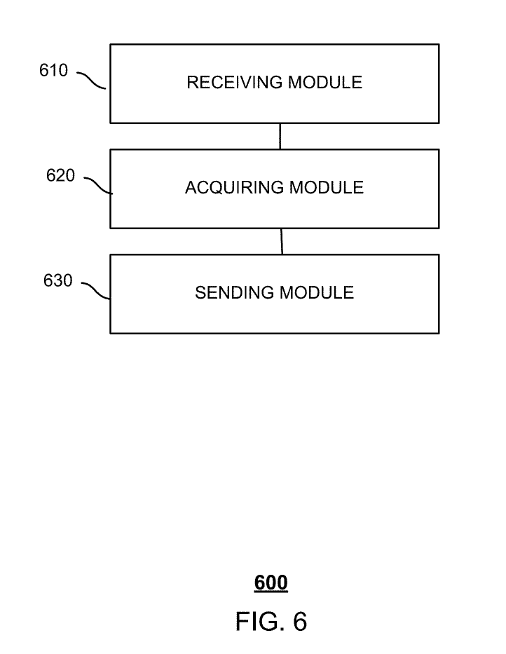

FIG. 6 is a functional structure of an embodiment of a server for application navigation. In some embodiments, the server corresponds to server 130 of FIG. 1, and includes: a receiving module 610, an acquiring module 620, and a sending module 630. In some embodiments, the receiving module 610 is configured to receive a content request sent by a client. In some embodiments, the acquiring module 620 is configured to acquire information associated with an application requested by the client based on the content request. The information associated with the application is for display in a service interface, and the service interface is associated with the application folder in which the application is located. In some embodiments, the sending module 630 is configured to send the acquired information back to the client.

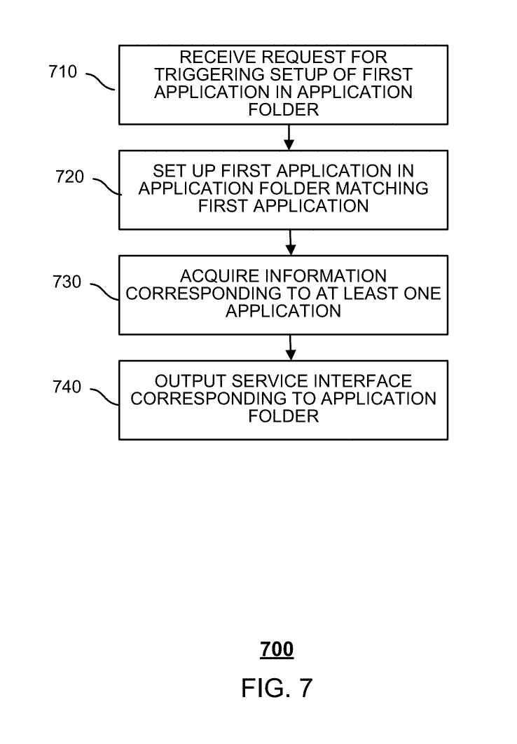

FIG. 7 is a flow chart of an embodiment of a process for application navigation. In some embodiments, the process 700 is implemented by a system 100 of FIG. 1 and describes the general process whereby an application folder is set up. As an example, the process 700 is described using the example of a client receiving a request for triggering setup of a first application in an application folder. In the example, the “first application” does not specify a specific application or specific applications, but serves as a convenient descriptive expression. In some embodiments, the process 700 includes:

In 710, the client receives a request for triggering setup of a first application in an application folder.

The first application can be an application that has been requested to be downloaded or installed. For example, in the event that a user requests download or installation of the first application, the process 700 can be triggered to set up the first application in an application folder associated with the first application.

The first application can be an application that has been requested to be added to a target application folder. The target application folder can be an application folder already created. For example, when the user requests that the first application be added to the target application folder, process 700 can be triggered to set up the first application in the target application folder.

The first application can also include multiple first applications selected to be merged into the same application folder. For example, in the event that the user selects multiple application icons on the desktop and requests the creation of an application folder to store these multiple application icons, process 700 can be triggered to set up the multiple applications in the application folder associated with the multiple applications.

Process 700 can also be triggered in response to a received desktop management command. The desktop management command can instruct applications set up on the desktop to be set up in application folders corresponding to set service interfaces with the applications set up on the desktop including first applications.

In 720, the client sets up the first application in an application folder matching the first application based on the request.

In 720, the client can, depending on the situation, perform the following operations:

In a first situation, the first application is an application that has been requested to be downloaded or installed. The client can determine, based on correspondences between the service interface and applications, the service interface corresponding to the first application and set up the first application in an application folder corresponding to the service interface where the application folder corresponds to the first application. In some embodiments, the application folder matching the first application has already been created. In some embodiments, the application folder matching the first application has not yet been created. In this operation, in the event that the client determines that an application folder matching the first application has already been established, then the client adds the first application to the application folder. As an aspect, the client can create an application folder corresponding to the first application and add the first application to the application folder.

In some embodiments, the client acquires correspondences of service interfaces to applications from a server. For example, after receiving the request in operation 710, the client acquires correspondences from the server so that the client can acquire the most current correspondences. The correspondences can be stored on the client to reduce network usage and processing delays. As an example, the client could, after acquiring the correspondences from the server, store the correspondences locally and set a duration of validity having a specific length of time so that the correspondences can be used to determine, within the duration of validity, the service interface corresponding to the first application. In some embodiments, the duration of validity is set by the client. In some embodiments, the duration of validity is set by the server. In the event that the duration of validity for the correspondences expires, the client can request the latest correspondences from the server.

In the event that an application folder matching first applications has already been created, applications previously set up in the application folder could no longer match the application folder as a result of the server having adjusted or updated the correspondences. In some embodiments, the client determines whether a corresponding application folder has been created based on the service interface corresponding to the first application. In the event that the client determines that the corresponding application folder has been created, then the client acquires applications included in the created application folder and determines whether the created application folder includes applications that do not match the service interface corresponding to the application folder based on the correspondences between the service interface and the applications. In the event that non-matching applications exist, then the client can delete the non-matching applications from the created application folder.

In a second situation, the first application is an application for which a request has been made to add the application to a target application folder, and the client determines the service interface corresponding to the first application and determines whether the service interface corresponding to the first application is consistent with the service interface corresponding to the target application folder based on the correspondences between service interfaces and applications. If the first application is consistent with the service interface, then the client can set up the first application in the target application folder. In some embodiments, the client acquires the correspondences of the service interfaces to the applications.

In some embodiments, applications that are previously set up in the application folder no longer match the application folder because the server adjusted the correspondences. In some embodiments, in this situation, the client acquires applications included in the target application folder and determines whether the target application folder includes applications that do not match the service interface corresponding to the application folder based on the correspondences between the service interface and the applications. In the event that the target application folder includes non-matching applications, then the client can delete the non-matching applications from the target application folder.

In a third situation, the first application includes multiple first applications selected to be merged into the same application folder, and the client determines the service interfaces corresponding to the multiple applications based on the correspondences between the service interface and the applications. In the event that the service interfaces corresponding to the multiple first applications are the same, the client creates an application folder corresponding to the service interface based on the service interfaces corresponding to the multiple first applications, and the multiple first applications are set up in the created application folder.

In some embodiments, the client acquires the correspondences of service interfaces to applications. For example, the client acquires the correspondences from the server.

In a fourth situation, in the process of setting up the first applications in the application folders matching the first applications based on a received desktop management command, the client can determine a service interface corresponding to each application set up on the desktop based on the correspondences between the service interfaces and the applications, create a corresponding application folder based on the service interface corresponding to each application set up on the desktop, and set up the desktop applications corresponding to the service interfaces in the corresponding application folders based on the service interfaces corresponding to the created application folders.

In some embodiments, the client acquires the correspondences of the service interfaces to the applications.

As an example of operation 720, the client sends an ID of the first application to the server and receives back, from the server, instruction information for the application folder matching the first application. The client sets up the first application in the application folder matching the first application.

In 730, the client acquires information corresponding to at least one application based on the at least one application included in the application folder.

In operation 730, the client can send a content request to the server. After the server receives the content request, the server can acquire the application content requested by the client based on the request and send the acquired application content back to the client. The content request can include an application ID so that the server can acquire content of the application corresponding to the application ID.

In some embodiments, the server can follow a content recommendation technique to acquire content recommendation information to be displayed in the service interface and send the content recommendation information back to the client. As an example, the server can determine content recommendation information based on the application's usage statistical data, user personalized information corresponding to the client, or a combination thereof, and send the determined content recommendation information back to the client. In one example regarding a video application, the server counts video application play instances for an interval of time and sends information relating to the 10 most-played video resources back to the client. In another example regarding the video application, the server acquires user personalized information (such as, for example, user preferences) corresponding to the client, determines types of video resources that the user plays more often based on the user personalized information, and sends video resources of the determined types back to the client.

Please note that the content recommendation techniques used by servers are not limited to those listed above.

In 740, the client is configured to output a service interface corresponding to the application folder. In some embodiments, the service interface includes the acquired information.

In operation 740, the client can acquire a display template used by the service interface and output the service interface based on the acquired display template. The lower parts of the screenshots of FIGS. 2B and 2C are examples of display templates. In some embodiments, the display template is stored locally by the client. In some embodiments, the client acquires the display template from service interface configuration information after acquiring the service interface configuration information from the server.

In process 700, which can be performed by the client 300 shown in FIG. 3, operation 710 can be performed by the receiving module 310, operation 720 can be performed by the setup module 320, operation 730 can be performed by the acquiring module 330, and operation 740 can be performed by the output module 340.

Based on client 500 of FIG. 5, operation 710 can be performed by the receiving module 510, operation 720 can be performed by the setup module 520, operation 730 can be performed by the acquiring module 540, and operation 740 can be performed by the output module 550.

Based on the server 600 of FIG. 6, the processing flow of the server in operation 730 can be separately performed by the receiving module 610, the acquiring module 620, and the sending module 630.

Referring back to FIG. 5, in some embodiments, based on process 700, the service interface can be created in the following contexts: the user creates the service interface when downloading an application, installing an application, or a combination thereof, the user adds an application to an existing service interface, and the user executes a desktop management command, such as, for example, “Classify All,” provided by the terminal desktop. The “Classify All” function can relate to creating application folders corresponding to server-configured service interfaces and, furthermore, creating service interfaces corresponding to the application folders.

The service interface creation process is described below using three separate examples: a user downloading an application, a user adding an application to a service interface, and a user performing the “Classify All” function.

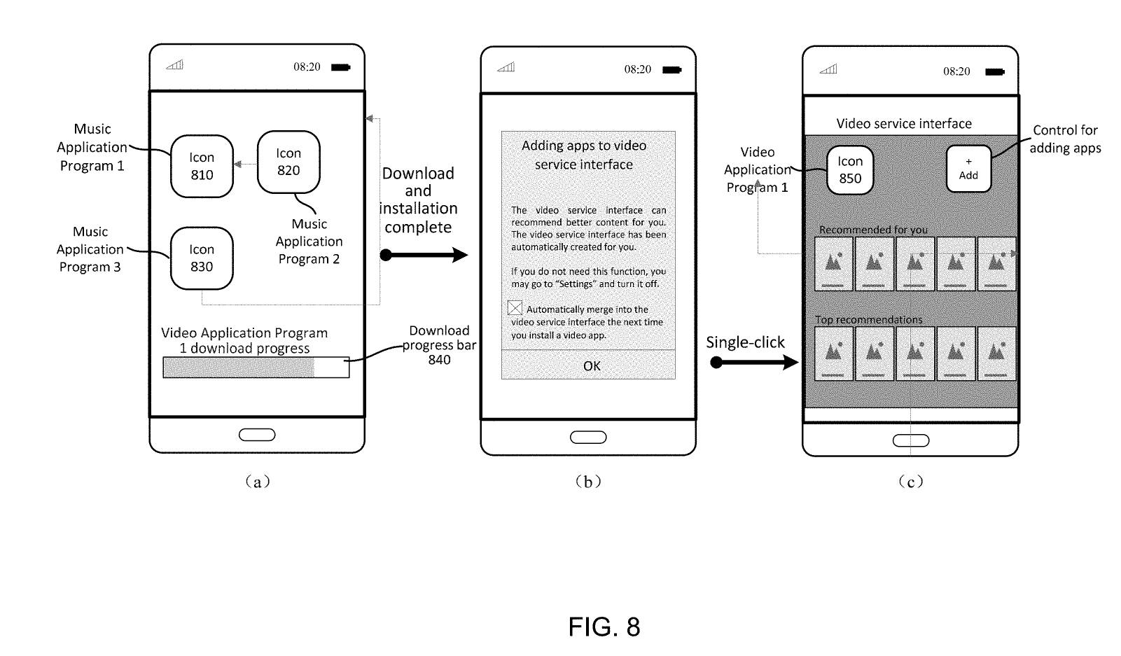

FIG. 8 is an example of a process for creating a service interface. As shown in FIG. 8 (a), the terminal desktop includes an icon 810 of Music Application Program 1, an icon 820 of Music Application Program 2, and an icon 830 of Music Application Program 3. Video Application Program 1 is shown as currently being downloaded. The desktop displays a download progress bar 840 relating to the download of Video Application Program 1. After Video Application Program 1 is downloaded and installed, a window pops up as shown in FIG. 8 (b). This pop-up window displays prompt information and an “OK” button to request the user to confirm whether to add Video Application Program 1 to the corresponding video service interface. In the event that the user single-clicks “OK,” the processing flow for the service interface starts. After the service interface processing flow finishes, the terminal desktop is to display the video service interface shown in FIG. 8 (c). The video service interface includes a portal for Video Application Program 1, which corresponds to icon 850 of Video Application Program 1, and content recommendation information.

In some embodiments, in FIG. 8 (b), in the event that the user selects the “Automatically merge into the video service interface the next time you install a video app” option, then following the subsequent download and installation of the video application program, the window does not again pop up, but instead the next step is to start the service interface processing flow.

The prompt process of FIG. 8 (b) is optional. In other words, after the video application program is downloaded and installed, the service interface processing flow can begin directly without having to prompt and request user confirmation.

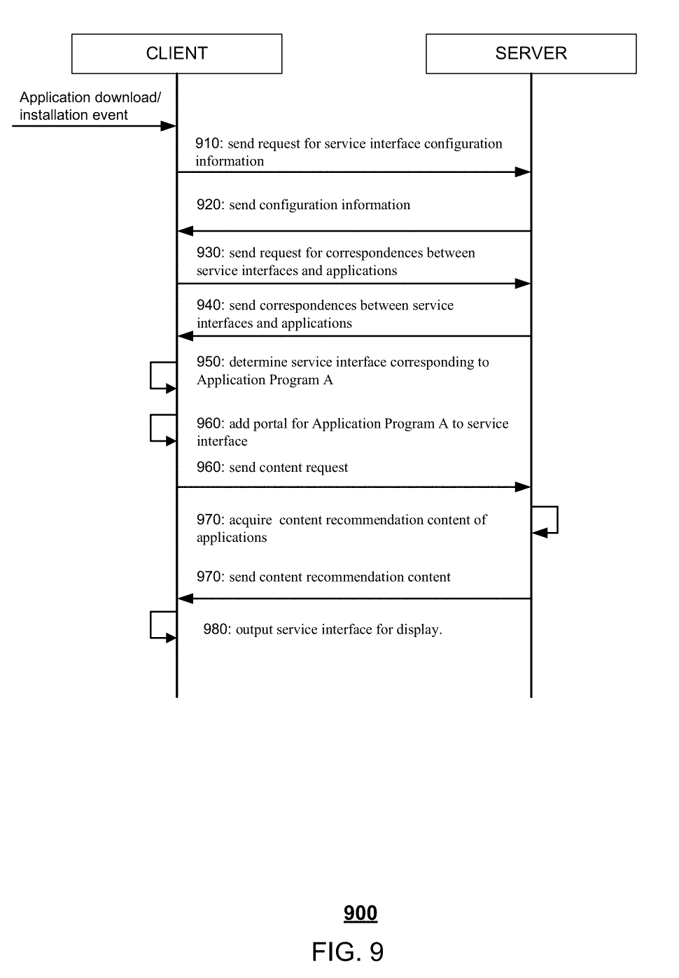

FIG. 9 is an example of a processing flow of a user downloading and installing an application program. In some embodiments, the process 900 is implemented by the system 100 of FIG. 1. The process 900 is described using an example of a user requesting download and installation of Application Program A.

Please note that “Application Program A corresponds to a service interface of a certain type” or similar wording has the same meaning as “Application Program A corresponds to or matches an application folder corresponding to a service interface of a certain type” because a type of service interface can correspond to applications of the corresponding type.

In some embodiments, the process 900 comprises:

In 910, after receiving an event relating to the download of an application, installation of an application, or a combination thereof, the client sends a request for service interface configuration information to the server.

In some embodiments, generation of an application program download event is triggered when the user launches an application program download, generation of an application program download completion event is triggered when the application program download is completed, an application program installation event is triggered after download of the application program is complete, and an application program installation completion event is triggered when installation of the application program is completed. After receiving an application program download event or a download completion event, the client can send a request to the server for service interface configuration information. The client can also send a request to the server for service interface configuration information after receiving an application program installation event or an installation completion event.

In 920, after receiving the request, the server sends, based on the request, configuration information for all types of service interfaces configured by the server back to the client. The client stores the received service interface configuration information after receiving the service interface configuration information from the server. The service interface configuration information can correspond to the service interface configuration information of other embodiments. For example, the service interface configuration information could relate to the service interface configuration information of Table 1, and will not be further discussed for conciseness.

In 930, the client sends a request to the server for correspondences between service interfaces and applications.

In 940, after receiving the request, the server sends the correspondences between the service interfaces and the applications back to the client. The correspondences between the service interfaces and the applications can correspond to the correspondences of other embodiments. For example, the correspondences could correspond with the correspondences of Table 2, and will not be further discussed for conciseness.

In some embodiments, operations 910 and 930 can be merged. In other words, the client can request interface configuration information and correspondences between service interfaces and applications from the server service through a single request. Accordingly, operations 920 and 940 can be merged. In other words, the server can send back to the client the service interface configuration information and the correspondences between the service interfaces and the applications through a single response. For example, the content sent back could correspond with the content shown in Table 2.

In 950, after receiving the correspondences, the client can determine the service interface corresponding to Application Program A based on the correspondences. The determination results can include the following situations:

In a first situation, Application Program A corresponds to a service interface of a certain type, and the service interface of the type has already been created or the application folder corresponding to the service interface has already been created. For example, the ID of Application Program A appears in an application list corresponding to a service interface of the video type, and the service interface of the video type has already been created.

In a second situation, Application Program A corresponds to a service interface of a certain type, but neither a service interface of the type has been created nor the application folder corresponding to the service interface has been created. For example, the ID of Application Program A appears in an application list corresponding to a service interface of the video type, but a service interface of the video type has not been created.

In a third situation, Application Program A does not correspond to a service interface of any type. For example, the ID of Application Program A does not appear in an application list corresponding to a service interface of any type.

The processing flow for the first situation comprises:

In 960, in cases where a service interface corresponding to Application Program A has already been created or the application folder corresponding to the service interface has already been created, the client adds the portal for Application Program A to the service interface, acquires applications included in the service interface (including the already added Application Program A), and sends a content request to the server. The content request includes the application IDs included in the service interface (including the ID of Application Program A).

In some embodiments, in cases where a service interface corresponding to Application Program A has already been created, the client, before adding the portal for Application Program A to the service interface, can also determine whether the service interface corresponding to Application Program A is a service interface defined in the service interface configuration information based on the service interface configuration information received in operation 920. In the event that the service interface corresponding to Application Program A is a service interface defined in the service interface configuration information, then subsequent processing can proceed. In the event that the service interface corresponding to Application Program A is not a service interface defined in the service interface configuration information, then the client can delete, from the desktop of the client, the service interface corresponding to Application Program A, as well as the corresponding application folder, and the client does not perform the subsequent process for acquiring recommendation content. As an example, the server can update service interface types, e.g., cancel the service interface of the video type. In performing process 900, the client can promptly subject the canceled service interface to appropriate processing based on adjustments made by the server to the service interface types.

In some embodiments, where a service interface corresponding to Application Program A has already been created, the client, after acquiring applications included in the service interface, can also determine whether the applications included in the service interface comply with the correspondences. Application programs that do not comply with the correspondences can be deleted from the service interface and the application folder corresponding to the service interface, and the IDs of the deleted application programs can be not included in the content request sent to the server. For example, Application Program B was added to the service interface corresponding to Application Program A. As an aspect, among the received correspondences, Application Program B is not included in the application list corresponding to the service interface and is deemed not to comply with the correspondences. Therefore, the client deletes Application Program B from the service interface and does not include the ID of Application Program B in the content request. In some embodiments, the server can update application lists corresponding to service interfaces. For example, the server deletes IDs of application programs for which a content recommendation service is no longer being provided from the application lists corresponding to the corresponding service interfaces. In such a situation, for those application programs for which content recommendation service is no longer being provided, the client can perform appropriate processing based on adjustments made by the server to the correspondences between the service interfaces and the application programs. As an example, appropriate processing includes deleting the application program.

In 970, after the server receives the request, the server acquires the content of the applications based on the ID of applications included in the request, and the server can further subject the acquired application content to processing based on a content recommendation technique, obtain content recommendation information, and then send the content recommendation content back to the client. The content recommendation technique can correspond to content recommendation techniques of other embodiments and will not be further discussed for conciseness.

In 980, after receiving the recommendation content, the client outputs the service interface for display. The service interface includes portals for the applications included in the service interface and the content recommendation information for these applications, the content recommendation information including the portal and content recommendation information for Application Program A.

Furthermore, in the event that the determination result in operation 950 corresponds with the second situation, then the process is to correspond to the process of FIG. 9. The client can create the corresponding service interface and the application folder based on Application Program A, and add the portal for Application Program A to the service interface. The client can acquire the recommendation content for Application Program A and display the service interface, the service interface including the portal, and the recommendation content for Application Program A.

Furthermore, in the event that the determination result in operation 950 corresponds with the third situation, then the client does not perform the process for creating a service interface.

In another example, the requests sent in operations 910 and 930 can include the ID of Application Program A. Accordingly, in operations 920 and 940, the server can send only the information relating to the service interface corresponding to Application Program A back to the client. For example, the server sends the configuration information for the service interface corresponding to Application Program A back to the client in operation 920. In operation 940, the server sends the application list for the service interface corresponding to Application Program A back to the client. This process reduces network resource expenditures and improves transmission efficiency because only the application list is sent by the server.

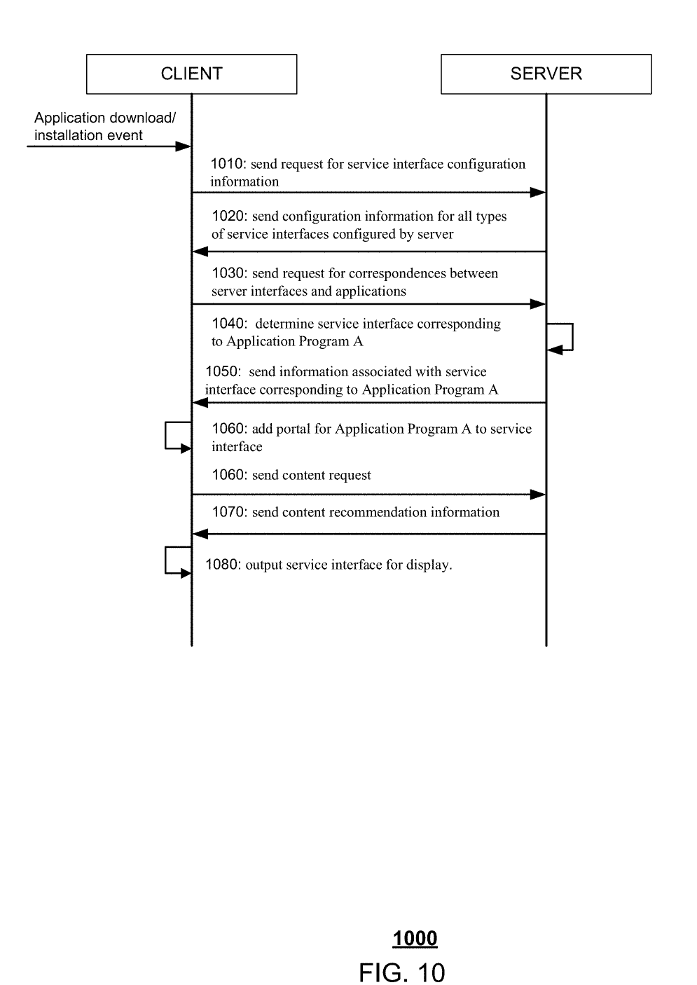

FIG. 10 is another example of a processing flow of a user downloading and installing an application program. In some embodiments, the process 1000 is implemented by the system 100 of FIG. 1. The process 1000 is described using the example of a user requesting download and installation of Application Program A and comprises:

In 1010, after receiving an event relating to download of an application, installation of an application, or a combination thereof, the client sends a request for service interface configuration information to the server. In some embodiments, operation 1010 corresponds with operation 910 of FIG. 9.

In 1020, after receiving the request, the server sends, based on the request, configuration information for types of service interfaces mentioned in the request back to the client. The client stores the service interface configuration information after receiving the service interface configuration information back from the server. The service interface configuration information can correspond to service interface configuration information of other embodiments. For example, the service interface configuration information could correspond to the service interface configuration information of Table 1, and will not be further discussed for conciseness.

In 1030, the client sends a request for correspondences between server interfaces and applications to the server. The request includes the ID of Application Program A and is for requesting the correspondences between the service interfaces and the applications relating to a service interface corresponding to Application Program A.

In 1040, after receiving the request, the server determines the service interface corresponding to Application Program A by using the ID of Application Program A included in the request to look up the correspondences of the service interfaces to the applications. The determination results can include the following situations:

In a first situation, Application Program A corresponds to a service interface of a certain type. For example, the ID of Application Program A appears in an application list corresponding to a service interface of the video type, and the service interface of the video type has already been created.

In a second situation, Application Program A does not correspond to a service interface of any type. For example, the ID of Application Program A does not appear in an application list corresponding to a service interface of any type, and the server send back null information.

FIG. 10 includes operations for the first situation, which include:

In 1050, the server sends information associated with the service interface corresponding to Application Program A back to the client. The associated information can include the type ID for the service interface. The associated information can also include correspondences between the interface and applications, i.e., an application list corresponding to the service interface.

In 1060, after receiving the service interface-associated information back from the server, the client determines whether the service interface corresponding to Application Program A has been created. In the event that the client determines that the service interface has been created, then the client adds a portal for Application Program A to the service interface, acquires the IDs of the applications included in the service interface (including the ID for Application Program A), and sends a content request to the server. The content request includes the IDs of the applications included in the service interface (including the ID of Application Program A). In the event that the client determines that the service interface has not been created, then the client creates the service interface corresponding to Application Program A and the corresponding application folder, and sends a content request to the server. The request includes the IDs of the applications included in the service interface (i.e., the ID of Application Program A).

In some embodiments, when the service interface corresponding to Application Program A has already been created, the client, after acquiring applications included in the service interface, also determines whether the applications included in the service interface comply with the correspondences based on the received correspondences. Applications failing to comply with the correspondences are deleted from the service interface and the application folder corresponding to the service interface, and the IDs of the deleted application programs are omitted from the content request sent to the server.

In 1070, after the server receives the request, the server acquires the content of the applications based on the IDs of the applications included in the request, and the server can subject the acquired application content to further processing based on a content recommendation technique, obtain content recommendation information, and then send the content recommendation information back to the client. The content recommendation technique can correspond with content recommendation techniques of other embodiments and will not be further discussed for conciseness.

In 1080, after receiving the recommendation content, the client displays the service interface. The service interface can include portals for the applications included in the service interface and the content recommendation information for the applications, the service interface including the portal and content recommendation information for Application Program A.

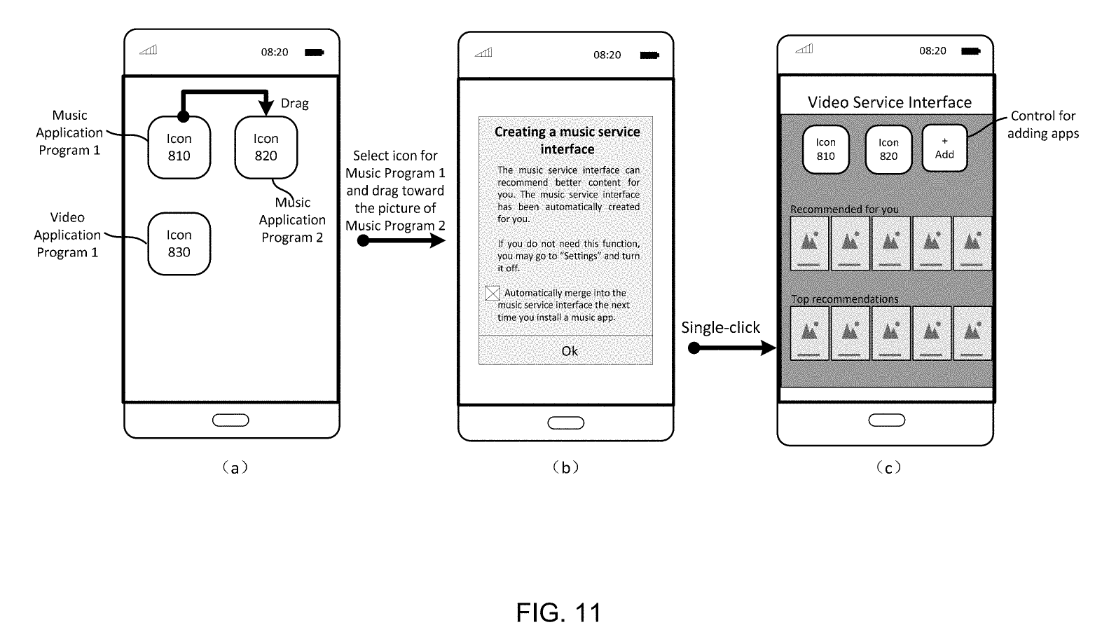

FIG. 11 is an example of how a terminal desktop changes when application programs of the same type are merged into a corresponding service interface. In FIG. 11 (a), the terminal desktop includes an icon 810 of Music Application Program 1, an icon 820 of Music Application Program 2, and an icon 830 of Video Application Program 1. After the user presses and holds the icon 810 for Music Application Program 1 and drags the icon 810 toward the position of the icon 820 for Music Application Program 2, the OS detects this action and causes a window to pop up as shown in FIG. 11 (b). This window displays prompt information and an “OK” button to request the user to confirm whether to create a music service interface for the selected Music Program 1 and Music Program 2. In the event that the user single-clicks “OK,” the processing flow for the service interface starts. After the service interface processing flow finishes, the terminal desktop is to display the music service interface shown in FIG. 11 (c). The music service interface includes a portal for Music Application Program 1, a portal for Music Application Program 2, content recommendation information for Music Program 1, and content recommendation information for Music Program 2.

In some embodiments, in FIG. 11 (b), in the event that the user selects the “Automatically merge into the music service interface the next time you install a music app” option, then, following the subsequent download and installation of the music application program, the window does not again pop up, and the next step is to start the service interface processing flow.

The prompt process described in FIG. 11 (b) is optional. In other words, after screen operations are used to create a music service interface for multiple music applications, the service interface processing flow can start without having to prompt and request user confirmation.

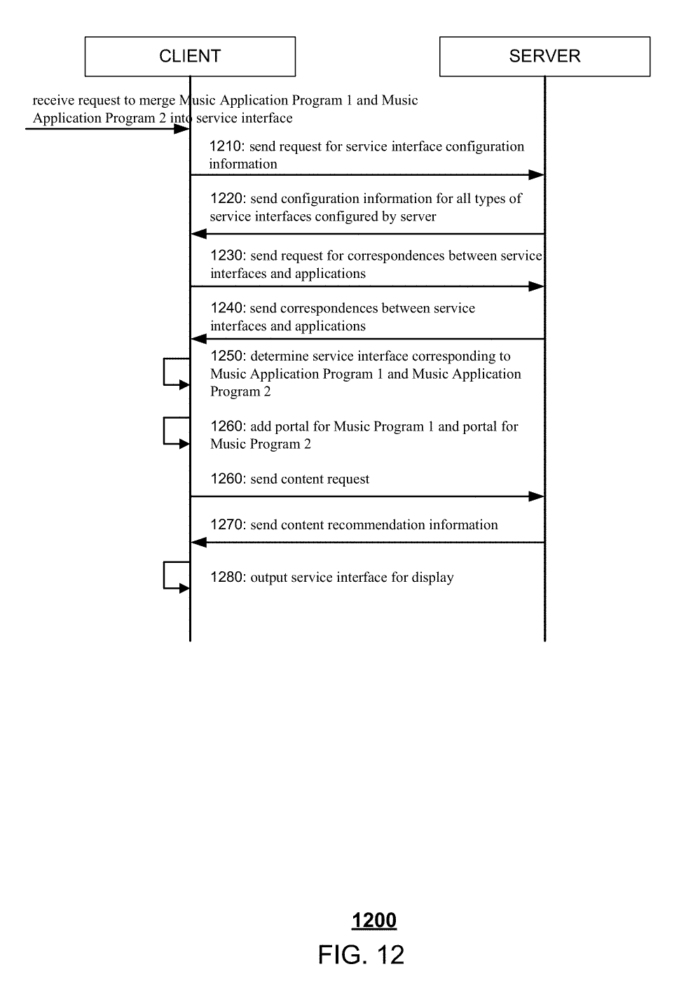

FIG. 12 is an example of a processing flow for merging multiple application programs into a corresponding service interface. The processing flow 1200 is described using an example of a user merging Music Application Program 1 and Music Application Program 2 into a service interface. The processing flow 1200 can include:

In 1210, after receiving a request to merge Music Application Program 1 and Music Application Program 2 into a service interface, the client sends a request for service interface configuration information to the server.

As an example, generation of the request can be triggered as shown in FIG. 11. After receiving the request to merge Music Application Program 1 and Music Application Program 2, the client sends the request for service interface configuration information to the server.

In 1220, after receiving the request for service interface configuration information, the server sends configuration information for all types of service interfaces configured by the server back to the client based on the request. The client stores the service interface configuration information after receiving the service interface configuration information back from the server. The service interface configuration information can correspond to service interface configuration information of other embodiments. For example, the service interface configuration information could correspond to the service interface configuration information of Table 1, and will not be further discussed here for conciseness.

In 1230, the client sends a request to the server for correspondences between service interfaces and applications.

In 1240, after receiving the request, the server sends the correspondences between the service interfaces and the applications back to the client. The correspondences between the service interfaces and the applications are similar to the correspondences described in other embodiments. For example, the correspondences could correspond to the correspondences of Table 2, and will not be further discussed for conciseness.

In 1250, after receiving the correspondences, the client can, based on the correspondences, determine whether the music-type service interface corresponding to Music Application Program 1 and Music Application Program 2 is a service interface defined by the server, i.e., whether both Music Application Program 1 and Music Application Program 2 correspond to the music service interface. If both Music Application Program 1 and Music Application Program 2 correspond to the music service interface, the client can continue with the process; otherwise, the client can end the process.

As an example, operations 1210 and 1230 can be merged. In other words, the client can request interface configuration information and correspondences between service interfaces and applications from the server through a single request operation. Accordingly, operations 1210 and 1230 can be merged. In other words, the server can send back to the client service interface configuration information and correspondences between service interfaces and applications through a single response operation. For example, the content sent back corresponds to the content of Table 2.

In 1260, the client adds a portal for Music Program 1 and a portal for Music Program 2 to the music service interface and sends a content request to the server. The content request includes the IDs of Music Program 1 and Music Program 2.

In 1270, after the server receives the content request, the server acquires the content of the applications based on the IDs included in the content request, and the server can subject the acquired content to further processing based on a content recommendation technique to obtain content recommendation information, and send the content recommendation information back to the client. The content recommendation technique could correspond to content recommendation techniques of other embodiments and will not be further discussed for conciseness.

In 1280, after receiving the content recommendation information, the client outputs the service interface for display. The service interface includes portals for Music Application Program 1 and Music Application Program 2 and the content recommendation information for Music Program 1 and Music Program 2.

In another example, the requests sent in operations 1210 and 1230 include the IDs of Music Application Program 1 and Music Application Program 2. Accordingly, in operations 1220 and 1240, the server can send the information relating to the service interface corresponding to Music Application Program 1 and Music Application Program 2 back to the client. For example, the server sends the configuration information for the music service interface corresponding to Music Application Program 1 and Music Application Program 2 back to the client in operation 1220. In 1240, the server sends the application list for the music service interface back to the client. The processing flow 1200 reduces network resource expenditures and improves transmission efficiency.

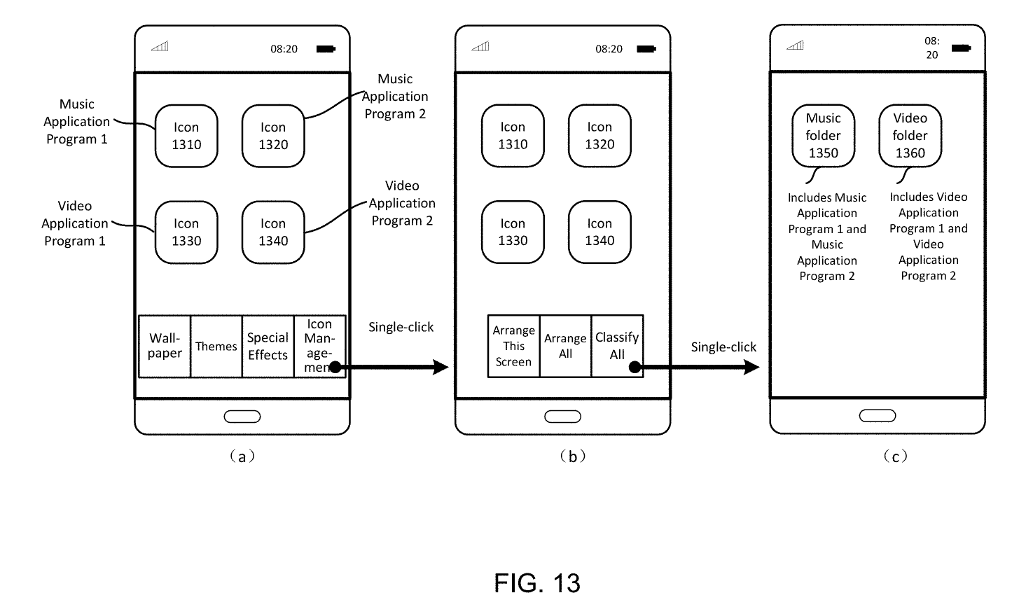

FIG. 13 is an example of how a terminal desktop changes in a context of executing a “Classify All” desktop management command. In FIG. 13 (a), the terminal desktop comprises an icon 1310 of Music Application Program 1, an icon 1320 of Music Application Program 2, an icon 1330 of Video Application Program 1, and an icon 1340 of Video Application Program 2. After the user single-clicks the “Icon Management” menu in the desktop management command menu, the “Icon Management” submenu is displayed as shown in FIG. 13 (b). After the user single-clicks the “Classify All” command in the “Icon Management” submenu, the processing flow for the service interface begins. After the service interface processing flow is completed, the terminal desktop is as shown in FIG. 13 (c). The terminal desktop includes an icon 1350 for the music folder and an icon 1360 for the video folder. The music folder includes Music Application Program 1 and Music Application Program 2. The video folder includes Video Application Program 1 and Video Application Program 2.

The assigning of application program icons to file folders triggered by the “Classify All” desktop management command is similar to the process 900 shown in FIG. 9 or the processing flow 1200 shown in FIG. 12. After receiving the “Classify All” icon management command, optionally, the client acquires, from the server, service interface configuration information and correspondences between service interfaces and applications. The client can, based on the acquired information, determine service interfaces corresponding to the application programs set up on the interface, create application folders corresponding to the service interfaces, and add icons for corresponding application programs to the appropriate application folders or the service interfaces corresponding to the application folders.

In some embodiments, regarding the application folders that already exist on the desktop, in the event that a service interface corresponding to an application folder is no longer the service interface defined by the service interface configuration information, then the adjustment of the service interface indicates that the application folder of that type has become invalid. Further, the client can remove the application program icons included in the invalid application folder, set the application program icons up on the desktop, and delete the invalid application folder from the desktop.

In some embodiments, regarding an application folder that already exists on the desktop, in the event that application programs included in the application folder are no longer in the application list for the corresponding service interface, then the client deletes the application programs from the folder and sets the application programs up on the terminal desktop.

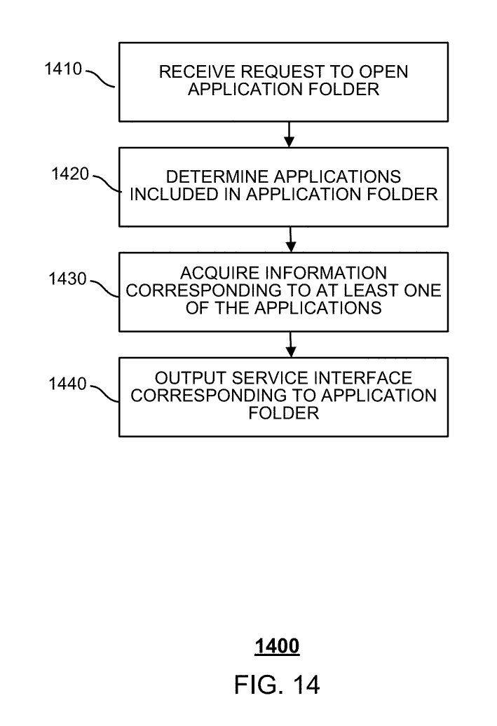

FIG. 14 is an example of a process whereby a service interface corresponding to an application folder is presented on a desktop when a user requests to open the folder. In some embodiments, the process 1400 is implemented by a terminal 110 of FIG. 1 or the client 400 of FIG. 4 and includes:

In 1410, the client receives a request to open an application folder.

In some embodiments, in the event that the user single-clicks an application folder on the desktop, the operating system is to generate a request to open the application folder and send the request to the client.

In 1420, the client determines the applications included in the application folder based on the request to open the application folder.

Operations 1410 and 1420 are described using the example of a user single-clicking an application folder on a terminal desktop as a way of triggering the generation of a “request to open an application folder.” Please note that the operation of triggering the generation of a “request to open an application folder” could correspond to another operation, such as, for example, an operation where the user swipes the terminal desktop. Other possibilities include that the generation of the “request to open an application folder” is triggered after the user enters the terminal desktop based on a user operation or a user gesture to unlock the screen or that the generation of the “request to open an application folder” is triggered based on an application program call.

In 1430, the client acquires information corresponding to at least one of the applications based on the applications included in the application folder.

In operation 1430, the client can send a content request to a server. The content request can include IDs of the applications. The applications that are sent back by the server to the client based on the content request can be used to present content in a service interface.

In 1440, the client outputs the service interface corresponding to the application folder. The service interface can include the acquired information.

In some embodiments, the information corresponding to the at least one application is content recommendation information determined by the server based on usage statistical data relating to the at least one application, user information relating to the at least one application, or a combination thereof.

In some embodiments, in operation 1440, the client determines the display template used by the corresponding service interface based on the service interface corresponding to the application folder. The client outputs the service interface corresponding to the application folder based on the determined display template.

In some embodiments, prior to operation 1420, the client acquires configuration information for the application folder. The configuration information of the application folder defines the type of the application folder and the applications or application types matching that type of application folder. The client determines whether the application folder includes unmatched applications based on application folder configuration information, and in the event that the application folder includes unmatched applications, then the client deletes the unmatched applications from the application folder.

Based on the client 500 of FIG. 5, operation 1410 can be performed by the receiving module 510, operation 1420 can be performed by the determining module 530, operation 1430 can be performed by the acquiring module 540, and operation 1440 can be performed by the output module 550.

Based on the server 600 of FIG. 6, the processing flow of the server in operation 1430 can be separately performed by the receiving module 610, the acquiring module 620, and the sending module 630.

Some embodiments can further shorten this process. In addition to having conventional application portals, the service interface can also aggregate and display the content of these applications. The content can include top recommendations, content typically browsed by the user, or content recommended for him or her. The user operation of going from one application to another application has been removed from the operations, and thus user navigation efficiency has been improved.

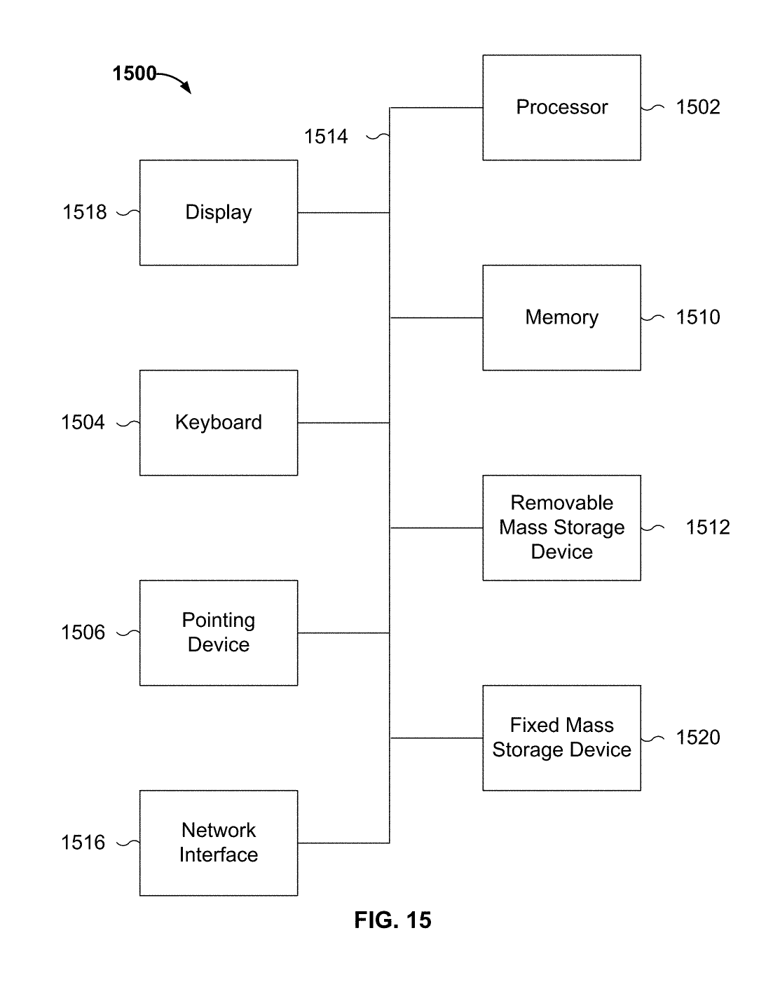

FIG. 15 is a functional diagram illustrating a programmed computer system for application navigation. As will be apparent, other computer system architectures and configurations can be used to perform application navigation. Computer system 1500, which includes various subsystems as described below, includes at least one microprocessor subsystem (also referred to as a processor or a central processing unit (CPU)) 1502. For example, processor 1502 can be implemented by a single-chip processor or by multiple processors. In some embodiments, processor 1502 is a general purpose digital processor that controls the operation of the computer system 1500. Using instructions retrieved from memory 1510, the processor 1502 controls the reception and manipulation of input data, and the output and display of data on output devices (e.g., display 1518).

Processor 1502 is coupled bi-directionally with memory 1510, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1502. Also as is well known in the art, primary storage typically includes basic operating instructions, program code, data, and objects used by the processor 1502 to perform its functions (e.g., programmed instructions). For example, memory 1510 can include any suitable computer-readable storage media, described below, depending on whether, for example, data access needs to be bi-directional or uni-directional. For example, processor 1502 can also directly and very rapidly retrieve and store frequently needed data in a cache memory (not shown).

A removable mass storage device 1512 provides additional data storage capacity for the computer system 1500, and is coupled either bi-directionally (read/write) or uni-directionally (read only) to processor 1502. For example, storage 1512 can also include computer-readable media such as magnetic tape, flash memory, PC-CARDS, portable mass storage devices, holographic storage devices, and other storage devices. A fixed mass storage 1520 can also, for example, provide additional data storage capacity. The most common example of mass storage 1520 is a hard disk drive. Mass storages 1512 and 1520 generally store additional programming instructions, data, and the like that typically are not in active use by the processor 1502. It will be appreciated that the information retained within mass storages 1512 and 1520 can be incorporated, if needed, in standard fashion as part of memory 1510 (e.g., RAM) as virtual memory.

In addition to providing processor 1502 access to storage subsystems, bus 1514 can also be used to provide access to other subsystems and devices. As shown, these can include a display monitor 1518, a network interface 1516, a keyboard 1504, and a pointing device 1506, as well as an auxiliary input/output device interface, a sound card, speakers, and other subsystems as needed. For example, the pointing device 1506 can be a mouse, stylus, track ball, or tablet, and is useful for interacting with a graphical user interface.

The network interface 1516 allows processor 1502 to be coupled to another computer, computer network, or telecommunications network using a network connection as shown. For example, through the network interface 1516, the processor 1502 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1502 can be used to connect the computer system 1500 to an external network and transfer data according to standard protocols. For example, various process embodiments disclosed herein can be executed on processor 1502, or can be performed across a network such as the Internet, intranet networks, or local area networks, in conjunction with a remote processor that shares a portion of the processing. Additional mass storage devices (not shown) can also be connected to processor 1502 through network interface 1516.

An auxiliary I/O device interface (not shown) can be used in conjunction with computer system 1500. The auxiliary I/O device interface can include general and customized interfaces that allow the processor 1502 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 15 is but an example of a computer system suitable for use with the various embodiments disclosed herein. Other computer systems suitable for such use can include additional or fewer subsystems. In addition, bus 1514 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining applications included in an application folder;
acquiring information corresponding to at least one of the applications based on the applications included in the application folder; and
outputting a service interface corresponding to the application folder, the service interface including an area to display the acquired information.

2. The method as described in claim 1, wherein:
the information corresponding to at least one of the applications includes one or more of the following:
content information provided by the at least one application; or
a content portal for the at least one application, the content portal providing an application for content information upon being triggered and activated or a resource corresponding to the content portal being accessed via the application;
the service interface includes one or more pieces of content information provided by the at least one application;
a piece of content information is associated with a portal for that piece of content information; and
the one or more pieces of content information are partitioned into multiple groups based on statistical dimensions.

3. The method as described in claim 2, wherein:
a group of content information occupies one display zone within the service interface;
at least a portion of pieces of content information of the group is displayed in the display zone;
in response to a determination that at least the portion of the pieces of content information of the group is displayed in the display zone, the display zone includes interface elements for triggering viewing of other pieces of content information in the group or provides a function whereby the other pieces of content information in the group are viewed via a swipe operation;
the content information provided by the at least one application appears in at least one of the following forms: text, pictures, video, animation, or real-time information; and
the information that is to be displayed in the service interface is acquired from a server.

4. The method as described in claim 3, wherein the information corresponding to the at least one application includes information recommended by the server, the recommended information being compiled by the server based on usage statistical data relating to the at least one application, user information relating to the at least one application, or a combination thereof.

5. The method as described in claim 1, wherein the outputting of the service interface corresponding to the application folder comprises:
acquiring a display template used by the service interface corresponding to the application folder; and
outputting the service interface corresponding to the application folder based on the display template.

6. The method as described in claim 1, wherein the determining of the applications included in the folder comprises:
receiving a request to open the application folder; and
determining the applications included in the application folder based on the request to open the application folder.

7. The method as described in claim 1, further comprising:
prior to the determining of the applications included in the folder:
acquiring configuration information for the application folder, the configuration information of the application folder defining a type of the application folder and the applications or application types matching the type of application folder;
determining whether the application folder includes unmatched applications based on the application folder configuration information; and
in response to the determination that the application folder includes the unmatched applications, deleting the unmatched applications from the application folder;
wherein:
application folders include applications of one or more types matching types of the application folders;
the service interface includes portals for the applications included in the application folder; and
the application portals are icon controls corresponding to the applications, and an icon control corresponding to an application activates the corresponding application upon being triggered.

8. A method, comprising:
receiving a request for triggering setup of a first application in an application folder, wherein the first application is an application that has been requested to be downloaded or installed;
setting up the first application in the application folder matching the first application based on the request, comprising:
determining a service interface corresponding to the first application; and
setting up the first application in the application folder corresponding to the service interface;
acquiring information corresponding to at least one application based on the at least one application included in the application folder; and
outputting the service interface corresponding to the application folder, the service interface including an area to display the acquired information.

9. The method as described in claim 8, further comprising:
determining whether the application folder corresponding to the service interface has been created based on the service interface corresponding to the first application; and
in response to a determination that the application folder corresponding to the service interface has not been created, creating the application folder corresponding to the service interface.

10. The method as described in claim 8, further comprising:
determining whether the application folder corresponding to the service interface has been created based on the service interface corresponding to the first application; and
in response to the determination that the application folder corresponding to the service interface has been created:
acquiring applications included in the created application folder;
determining whether the created application folder includes applications not matching the service interface corresponding to the application folder; and
in response to the determination that unmatched applications exist, deleting the unmatched applications from the created application folder.

11. The method as described in claim 8, wherein:
the first application is an application that a request has been made to add the application to a target application folder;
the setting up of the first application in the application folder matching the first application comprises:
determining the service interface corresponding to the first application;
determining whether the service interface corresponding to the first application is consistent with a service interface corresponding to the target application folder; and
in response to the determination that the service interface corresponding to the first application is consistent with the service interface corresponding to the target application folder, setting up the first application in the target application folder; and
the method further comprises:
acquiring applications included in the target application folder; and
after determining whether the target application folder includes applications not matching the service interface corresponding to the application folder, deleting the non-matching applications from the target application folder.

12. The method as described in claim 8, wherein:
the first application includes multiple first applications selected to be merged into the same application folder; and
the setting up of the first application in the application folder matching the first application comprises:
individually determining service interfaces corresponding to the multiple first applications; and
in response to a determination that the service interfaces corresponding to the multiple first applications are the same:
creating an application folder corresponding to the service interfaces based on the service interfaces corresponding to the multiple first applications; and
setting up the multiple first applications in the created application folder.

13. The method as described in claim 8, wherein the setting up of the first application in the application folder matching the first application comprises:
receiving a desktop management command for instructing applications set up on a desktop to be set up in applications folders corresponding to service interfaces, the applications set up on the desktop comprising first applications;
determining a service interface corresponding to an application set up on the desktop;
creating a corresponding application folder based on the service interface corresponding to the application set up on the desktop; and
setting up, from among the applications set up on the desktop, applications corresponding to the service interface in a corresponding application folder based on the service interface corresponding to the created application folder, wherein the applications set up in the corresponding application folder comprise the first applications.

14. The method as described in claim 8, wherein the setting up the first application in the application folder matching the first application comprises:
sending an identifier (ID) of the first application to a server;
receiving, from the server, instruction information for the application folder matching the first application; and
setting up the first application in the application folder matching the first application.

15. The method as described in claim 8, wherein the outputting of the service interface corresponding to the application folder comprises:
acquiring a display template used by the service interface; and
outputting the service interface based on the acquired display template.

16. The method as described in claim 15, further comprising:
acquiring service interface configuration information from a server, the service interface configuration information comprising display templates used by service templates.

17. The method as described in claim 8, wherein the information corresponding to the at least one application includes content recommendation information, the content recommendation information being compiled based on usage statistical data relating to the application, user information relating to the application, or a combination thereof.

18. The method as described in claim 8, wherein the service interface comprises portals for application programs included in the application folder.

19. A method, comprising:
receiving a content request sent by a client;
acquiring information corresponding to an application requested by the client based on the content request, the information corresponding to the application being for display in a service interface, the service interface corresponding to an application folder in which the application is located; and
sending the acquired information back to the client.

20. The method as described in claim 19, wherein:
the acquiring of the information corresponding to the application requested by the client comprises:
acquiring the information corresponding to the application requested by the client based on usage statistical data, user information corresponding to the client, or both;
the content request comprises an identifier (ID) of the application requested by the client; and
the acquiring of the information corresponding to the application requested by the client comprises:
acquiring the information corresponding to the application based on the ID of the application included in the content request; and
the method further comprises:
receiving a request for service interface configuration information sent by the client;
sending the service interface configuration information back to the client based on the request for the service interface configuration information;
receiving a request sent by the client for correspondences between service interfaces and applications, wherein the request for the correspondences between the service interfaces and the applications comprises application IDs; and
sending the correspondences back to the client based on the request for the correspondences between the service interfaces and the applications, comprising:
determining the service interfaces corresponding to the application IDs included in the request for the correspondences between the service interfaces and the applications; and
sending the correspondences between the determined service interfaces and the applications back to the client.

21. A client, comprising:
a processor; and
a memory coupled with the processor, wherein the memory is configured to provide the processor with instructions which when executed cause the processor to:
determine applications included in an application folder;
acquire information corresponding to at least one of the applications based on the applications included in the application folder; and
output a service interface corresponding to the application folder, the service interface including an area to display the acquired information.
